(19) United States
(12) Patent Application Publication
(10) Pub. No.: US 2013/0140140 A1
(43) Pub. Date: Jun. 6, 2013

(54) SYSTEM FOR CONTROLLING SLURRY ON A COUNTER CURRENT BELT WASHER

(71) Applicant: Gregory Daniel Zilker, Brush Prairie, WA (US)

(72) Inventor: Gregory Daniel Zilker, Brush Prairie, WA (US)

(21) Appl. No.: 13/309,487

(22) Filed: Dec. 1, 2011

(51) Int. Cl. B65G 45/22; B65G 45/10

(52) U.S. Cl. 198/495; 198/494

(57) ABSTRACT

A traveling deckle is adapted to run on each edge of a filter belt in a counter current belt washer system. The traveling deckle may be used to retain a slurry on the filter belt as the filter belt is passed through one or more vacuum and washing stages. The traveling deckle may be driven by the friction of the deckle against the belt. After the last vacuum point of liquor removal, the deckle returns to its starting point in an endless run. The deckle eliminates conventional curbing and troughing.

### BACKGROUND OF THE INVENTION

The present invention relates to horizontal belt washer systems and, more particularly, to a system for controlling slurry on a counter current belt washer.

Horizontal belt washers are, in broad terms, the most commonly used vacuum filters in chemical industry due to their flexibility of operation, adaptation to corrosive slurries and suitability to handle large throughputs.

On conventional counter current horizontal belt washers, slurry is deposited on a filter belt. In order to keep the slurry on the filter belt, some machines incorporate a vacuum carrier belt that is either flanged on the edges (these flanges sometimes referred to as curbs or curbing) or the belt edges are troughed. The curbing is very expensive, very time consuming to vulcanize on the belt and the bond between the curbing and the belt often breaks, creating leakage. and need for repair. Some filter belts run in a trough on a carrier belt, or without the carrier belt. Troughing limits the filter belt designs, often results in a loss of vacuum at the trough, reducing liquor removal, and is more demanding of the mechanical splice to make the conveyor belt endless.

As can be seen, there is a need for an improved system for retaining the slurry on a counter current belt washer.

### SUMMARY OF THE INVENTION

In one aspect of the present invention, a conveyor system comprises a belt for carrying product on the conveyor; and a traveling deckle disposed along each side of the belt to retain the product on the conveyor, wherein the traveling deckle is separate from the belt and moves along with motion of the belt by friction between the traveling deckle and the belt.

In another aspect of the present invention, a counter current belt washer comprises a filter belt for carrying a slurry on the filter belt; a traveling deckle disposed along each side of the filter belt to retain the slurry on the filter belt; one or more stationary deckles disposed at edges of the filter belt, wherein the stationary deckles are disposed between the slurry and the traveling deckle; a headbox pulley adapted to guide the traveling deckle against a belt edging of the belt, adjacent to the stationary deckle, near a location where the slurry is applied to the filter belt; and a terminal pulley adapted to guide the traveling deckle off the belt edging and return the traveling deckle to the upstream pulley at a location where the slurry is self-retained on the filter belt, wherein the traveling deckle is separate from the belt and moves along with motion of the belt by friction between the traveling deckle and the belt.

These and other features, aspects and advantages of the present invention will become better understood with reference to the following drawings, description and claims.

### BRIEF DESCRIPTION OF THE DRAWINGS

FIG. 1 is a perspective view of a counter current belt washer according to an exemplary embodiment of the present invention;

FIG. 2 is a side view of the counter current belt washer of FIG. 1 with a traveling deckle;

FIG. 3 is a close-up side view of a traveling deckle terminal pulley of the traveling deckle on the counter current belt washer of FIG. 1;

FIG. 4 is a section view taken along line 4-4 of FIG. 2;

FIG. 5 is a section view taken along line 5-5 of FIG. 1;

FIG. 6 is a close-up side view of a traveling deckle headbox pulley of the counter current belt washer of FIG. 1; and

FIG. 7 is a close-up side view of the traveling deckle terminal pulley of FIG. 3, showing a belt tensioning adjustment.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a traveling deckle that is adapted to run on each edge of a filter belt in a counter current belt washer system. The traveling deckle may be used to retain a slurry on the filter belt as the filter belt is passed through one or more vacuum and washing stages. The traveling deckle may be driven by the friction of the deckle against the belt. After the last vacuum point of liquor removal, the slurry being filtered may be a cake and the deckle may no longer be needed. The deckle then returns to its starting point in an endless run. The deckle eliminates conventional curbing and troughing.

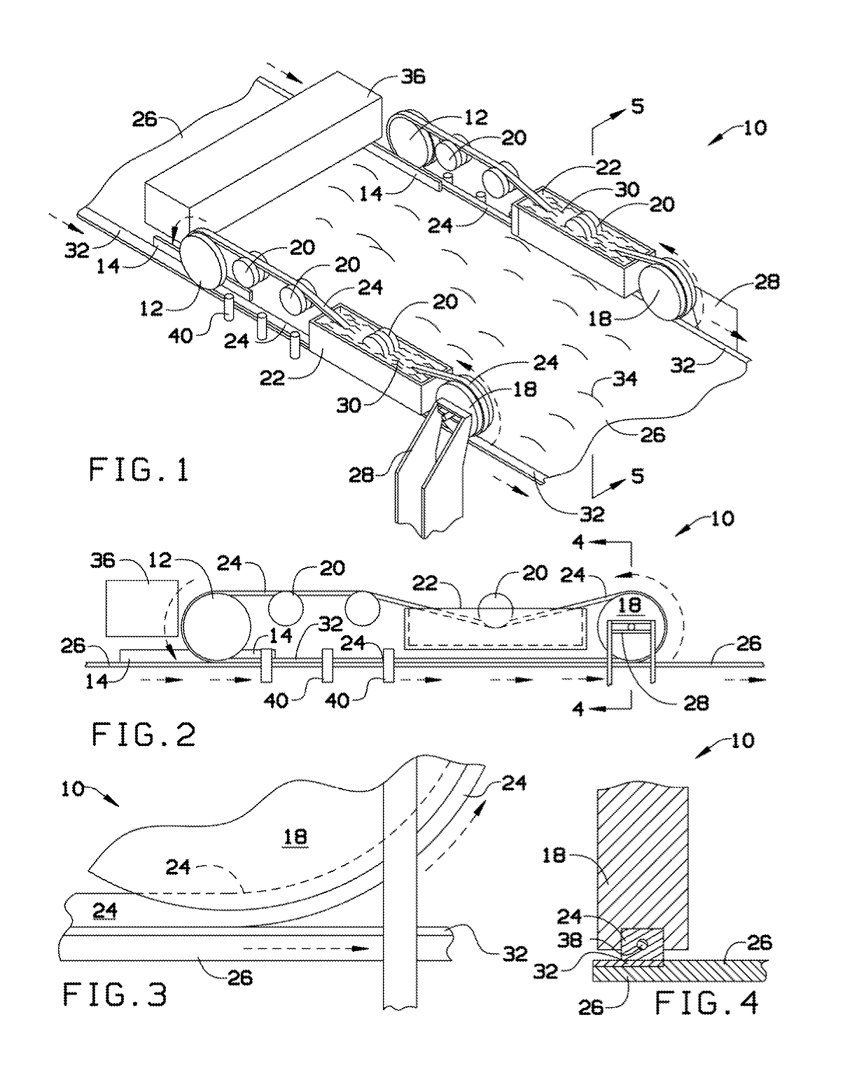

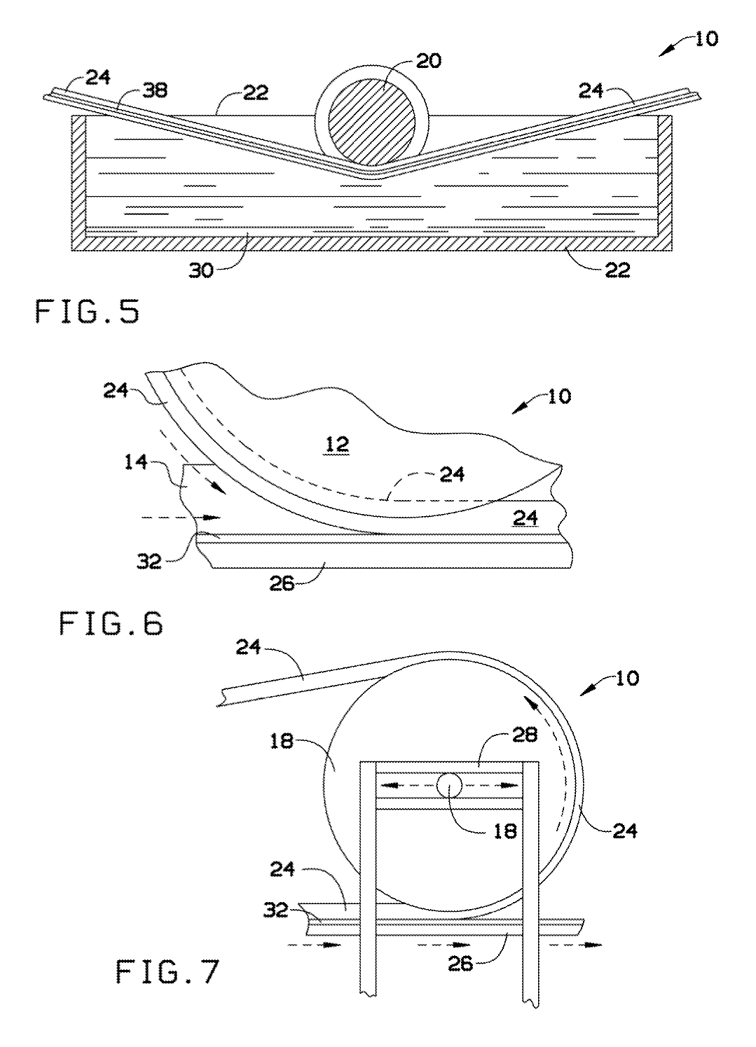

Referring now to FIGS. 1 through 7, a counter current belt washer 10 may include a filter belt 26 adapted to carry a slurry 34 deposited thereupon by a headbox 36. The slurry 34 may be passed through one or more vacuum stages and one or more wash stages, as is known in the art for counter current belt washers.

A headbox pulley 12 may be disposed at each edge of the filter belt 26 proximal to the headbox 26. A terminal pulley 18 may be disposed at each edge of the filter belt 26 at a location downstream of the final wash stage. Typically, the terminal pulley 18 may be disposed at a location along the filter belt 26 where the cake remaining on the filter belt is firm and no longer requires an edging along the filter belt 26 to keep the cake of slurry from coming off the filter belt 26. A traveling deckle 24 may be adapted to span between the headbox pulley 12 and the terminal pulley 18.

The headbox pulley 12 and the terminal pulley 18 may be disposed to create friction between the traveling deckle 24 and a filter belt edging 32. This friction may move the traveling deckle 24 along with the movement of the filter belt 26. The traveling deckle 24 may travel along with the moving filter belt 26, providing a lip at each edge of the filter belt 26 to retain the slurry 34 thereupon. One or more deckle guide rollers 40 may keep the traveling deckle 24 from moving off the edge of the filter belt 26. The belt edging 32 may be a sealant, typically of urethane or rubber compounds. Belt edging 32 is typically used in a filter belt to chemically lock the porous edges of the filter belt to protect the belt from unraveling. Typical belt edging 32 is about 1 inch wide. The filter belt 26 of the present invention may have a belt edging 32 that is wider than the typical 1 inch and wider than the traveling deckle 24. In application, the traveling deckle 24 may be inside the edge of the filter belt 26. By sealing the filter belt edge wider than the traveling deckle 24, there may be no vacuum loss in the filter belt 26 outside of the traveling deckle 24.

The traveling deckle 24 may be removed from the filter belt edging 32 at the terminal pulley 18. The traveling deckle 24 may then pass over one or more return pulleys 20 to return back to the headbox pulley 12.

A bath box 22 may be disposed along the return path of the traveling deckle 24. The bath box 22 may be, for example, stainless steel and may contain a bath liquid 30. One or more of the return pulleys 20 may direct the traveling deckle 24 into the bath box 22 to be washed by the bath liquid 30. In some embodiments, the bath liquid 30 may be water. In other embodiments, the bath liquid 30 may be some other solvent, for example, one of the wash solvents used in the washing of the slurry 34 as it moves along the belt washer system 10.

Referring to FIG. 4, the terminal pulley 18 may be doubled flanged to retain the traveling deckle 24 between its flanges. The traveling deckle 24 may be made from a variety of materials, including steel, aluminum, plastic, rubber, composite, urethane, silicone, or the like. In some embodiments, as shown in FIG. 4, a synthetic cord or steel core 38 may be centrally disposed along the length of the traveling deckle 24. The return pulleys 20 may also be double flanged, similar to the terminal pulley 18.

The headbox pulley 12 may be a single flanged pulley adapted to have its single flange on a side away from the filter belt 26. In this configuration, the headbox pulley 12 may deliver the traveling deckle 24 adjacent to a stationary deckle 14 that may be disposed from the headbox 36 to a position downstream of the headbox 36 where the traveling deckle 24 is disposed in the filter belt edging 32. One or more stationary deckles 14 may be disposed along the belt washer system 10. For example, if a wash liquid may be corrosive to the traveling deckle 24, the wash area along the belt washer system 10 using this corrosive wash liquid may use a stationary deckle 14 to contain the slurry 34 and the traveling deckle 24 may simply pass behind the stationary deckle 14.

The terminal pulley 18 may be mounted on a support/tension adjustment bracket 28. A slot in the bracket 28, for example, may provide a mechanism for tightening the traveling deckle 24 to a proper tension. Typically the proper tension would be such that there is no deckle to pulley slippage in the traveling deckle 24. The bracket 28 may also provide a mechanism for loosening the traveling deckle 24 to remove it for repair, inspection or replacement.

While the above description describes a counter current belt washer system, the design of the present invention may be applicable to other systems. The present invention could be used on any conveyor that requires limiting of controlling the flow of product in a process area of the conveyor, replacing curbs or belt flanges currently being used to contain product.

It should be understood, of course, that the foregoing relates to exemplary embodiments of the invention and that modifications may be made without departing from the spirit and scope of the invention as set forth in the following claims.

What is claimed is:

1. A conveyor system comprising:
a belt for carrying product on the conveyor; and
a traveling deckle disposed along each side of the belt to retain the product on the conveyor, wherein
the traveling deckle is separate from the belt and moves along with motion of the belt by friction between the traveling deckle and the belt.

2. The conveyor system of claim 1, further comprising:
an upstream pulley adapted to guide the traveling deckle against a belt edging of the belt; and
a downstream pulley adapted to guide the traveling deckle off the belt edging and return the traveling deckle to the upstream pulley.

3. The conveyor system of claim 2, further comprising one or more guide pulleys adapted to guide the traveling deckle from the downstream pulley to the upstream pulley.

4. The conveyor system of claim 3, further comprising a bath box adapted to contain a bath liquid, wherein one or more of the guide pulleys are adapted to guide the traveling deckle into the bath box.

5. The conveyor system of claim 1, further comprising one or more deckle guide rollers adapted to retain the traveling deckle at the belt edging.

6. The conveyor system of claim 1, further comprising one or more stationary deckles disposed at edges of the belt, wherein the stationary deckles are disposed between the product and the traveling deckle.

7. The conveyor system of claim 6, wherein the upstream pulley is a single flanged pulley adapted to deliver the traveling deckle adjacent to at least a portion of the stationary deckle.

8. A counter current belt washer comprising:
a filter belt for carrying a slurry on the filter belt;
a traveling deckle disposed along each side of the filter belt to retain the slurry on the filter belt;
one or more stationary deckles disposed at edges of the filter belt, wherein the stationary deckles are disposed between the slurry and the traveling deckle;
a headbox pulley adapted to guide the traveling deckle against a belt edging of the belt, adjacent to the stationary deckle, near a location where the slurry is applied to the filter belt; and
a terminal pulley adapted to guide the traveling deckle off the belt edging and return the traveling deckle to the upstream pulley at a location where the slurry is self-retained on the filter belt, wherein
the traveling deckle is separate from the belt and moves along with motion of the belt by friction between the traveling deckle and the belt.

9. The counter current belt washer of claim 8, further comprising one or more guide pulleys adapted to guide the traveling deckle from the downstream pulley to the upstream pulley.

10. The counter current belt washer of claim 8, further comprising a bath box adapted to contain a bath liquid, wherein one or more guide pulleys are adapted to guide the traveling deckle into the bath box.
